(19) United States
(12) Patent Application Publication
(10) Pub. No.: US 2024/0198984 A1
(43) Pub. Date: Jun. 20, 2024

(54) METHOD FOR BRAKE CONTROL OF A VEHICLE COMBINATION AND BRAKE CONTROL SYSTEM FOR OPERATING THIS METHOD

(71) Applicant: ZF CV Systems Global GmbH, Bern (CH)

(72) Inventors: Tobias Hauschild, Seelze (DE); Matthias Kemmerling, Braunschweig (DE)

(73) Assignee: ZF CV Systems Global GmbH, Bern (CH)

(21) Appl. No.: 18/538,425

(22) Filed: Dec. 13, 2023

(30) Foreign Application Priority Data
Dec. 19, 2022 (DE) 10 2022 213 831.7

(51) Int. Cl. B60T 8/17; B60Q 5/00; B60Q 9/00; B60T 7/20; B60W 10/02; B60W 10/10; B60W 10/18; B60W 10/184; B60W 30/18

(52) U.S. Cl. CPC B60T 8/1701; B60Q 5/005; B60Q 9/00; B60T 7/20; B60W 10/02; B60W 10/10; B60W 10/182; B60W 10/184; B60W 30/18109; B60T 2250/04; B60W 2300/14; B60W 2510/18; B60W 2520/10; B60W 2520/105; B60W 2520/12; B60W 2520/28; B60W 2530/203; B60W 2555/00; B60W 2710/021; B60W 2710/1005; B60W 2710/18

(57) ABSTRACT

A method for controlling the brakes of a vehicle combination having a towing vehicle and an attached accessory device or at least one trailer vehicle coupled to the towing vehicle. The vehicle combination comprises an electronic brake system and first sensor means for determining the driving speed, where at least the towing vehicle comprises a friction brake system that can be actuated by the brake control system, and where at least the coupled attached accessory device or trailer vehicle has second sensor means for recognizing a need to brake the vehicle combination and for signaling a braking demand. A signaled braking demand is communicated directly or indirectly to the brake control system, and the vehicle combination is braked automatically by the brake control system actuating the friction brake system of the towing vehicle.

### RELATED APPLICATIONS

This application claims the benefit of and right of priority under 35 U.S.C. § 119 to German Patent Application no. 10 2022 213 831.7, filed on 19 Dec. 2022, the contents of which are incorporated herein by reference in its entirety.

### FIELD OF THE DISCLOSURE

The invention relates to a method for controlling the brakes of a vehicle combination that comprises a towing vehicle and an attached accessory device or at least one trailer vehicle coupled onto the towing vehicle, wherein the vehicle combination comprises an electronic brake control system and first sensor means for determining the speed of the vehicle, such that at least the towing vehicle comprises a friction brake system that can be controlled by the brake control system, and wherein at least the coupled-on attached accessory device or trailer vehicle comprises second sensor means for recognizing that the vehicle combination needs to be braked and for signaling a braking requirement. Furthermore, the invention relates to an electronic brake control system of a vehicle combination with a towing vehicle and an attached accessory device or a trailer vehicle that can be coupled onto the towing vehicle, as well as a vehicle combination of such a type.

### BACKGROUND

Off-highway vehicles, such as agricultural tractors or other towing vehicles, often travel away from roadways. For example, these vehicles carry out agricultural work on fields, and perform tasks on building sites and in public areas with purpose-specific accessory equipment or trailers which are coupled to such a towing vehicle. The sensors and/or control units of many attached accessory devices or trailer vehicles to be found on the market are already capable of communicating with a control unit on the towing vehicle by way of a standard electronic bus interface. In modern vehicle combinations the towing vehicle can already receive dynamic control commands from an attached accessory device or trailer vehicle, for example in order to adopt an optimum driving speed for a particular task or installation position. Such vehicle combinations have electronically controlled drive systems that are increasingly sophisticated in order to control and, if necessary, regulate the movement of the vehicle combination. This can be done, for example, by controlling the transmission ratio of a continuously variable transmission in the drivetrain as well as controlling the drive motor. The friction brakes and parking brakes needed in all off-highway vehicles in order to be certain of reaching a prescribed deceleration of the vehicle both while driving on roads and also cross-country, can be actuated manually by the driver.

The communications between an agricultural towing vehicle and an attached accessory device or trailer vehicle coupled to it are continually being developed further by the body responsible for electronics in agriculture, AEF (Agricultural Industry Electronics Foundation), under the heading Tractor Implement Management (TIM), together with the ISOBUS Standard ISO 11783 for agricultural applications (Internet: www.aef-online.org/de/ueber-uns/activities/tractor-impl-management-tim.html). According to this, TIM is a comprehensive list of products and manufacturers of functions in the agricultural technology industry, in which an attached accessory device can communicate electronically and bidirectionally with a tractor in order to control certain tractor functions, such as the driving speed, whereby the attached accessory device optimizes its own operation by virtue of control commands to the tractor. For this, as a physical interface the agricultural technology data bus application ISOBUS, which complies with the ISO 11783 Standard, is used. ISOBUS enables the control of various types of attached accessory devices produced by various manufacturers with an existing terminal unit, wherein the communication is based on the SAE J1939 network protocol which defines communication on a CAN bus in utility vehicles for the exchange of diagnostic data and control information.

A braking requirement to brake the vehicle combination can arise by virtue of working sequences during normal operation or because a hazardous situation has been recognized. In fields, forests, or work-sites hazardous situations can occur which are quite different from situations that are encountered on roads. Besides the familiar functions of avoiding collisions or protecting pedestrians while driving on roads, other events when an attached accessory device or a trailer vehicle is being used may require the vehicle combination to be stopped. Such situations, for example, are the presence of animals in a harvesting area during the harvest, and the possibility that a wide attached accessory device might collide with field obstacles such as hedges or power pylons, or objects that could possibly damage the implement severely, such as boulders or scrap metal. The attached accessory device or trailer vehicle must be able to recognize such situations itself and is for that purpose equipped with appropriate sensors, which are optimized for the application concerned. In such cases the attached accessory device or trailer vehicle signals a braking command, for example by way of the ISOBUS interface, to a control unit in the towing vehicle.

However, until now only such functions have been implemented in the tractor implement management TIM system which, in the event of a braking command from the attached accessory device or trailer vehicle, call for only a relatively moderate deceleration of the speed of travel, which can be achieved in most cases by means of the drivetrain by throttling-down the drive motor and/or changing the transmission ratio in a transmission present in the drivetrain. For example, in that way a shift between forward driving and driving in reverse can be controlled automatically. Deceleration control by way of the vehicle transmission when the tractor implement management TIM system is in use, is moreover only available with a continuously variable transmission but not in vehicles with a powershift transmission, which are still commonplace in vehicle combinations of that type.

Since the possibilities of the drivetrain for decelerating the vehicle combination are limited, the driver must always himself be able to actuate the friction brakes, at least of the towing vehicle, in order to achieve appropriate deceleration and ensure safety in any driving situation. However, the driver's reaction after a warning from the attached accessory device that he can see and/or hear could be too slow in a critical situation, such as in unforeseeable situations that demand an immediate and rapid response to avoid accidents involving animals or damage to the equipment or to other objects in the surroundings. Furthermore, it is likely in the future that driving speeds on fields or farmlands will increase, autonomous machine functions in agriculture will be extended, and the costs for the use or repair of new high-tech machinery, even after slight accidents or damage, will increase substantially.

From the document 97+404.DE.0821 “SENSOSAFE assistance system for animal recognition” by the firm Pöttinger Landtecknik GmbH, an automated animal recognition assistance system for use by tractors with a mower on meadowland is known. If any wildlife is detected, an operator terminal emits both a visual and an acoustic warning signal for the driver. The driver then has to brake the tractor manually to avoid colliding with the animal.

From EP 2 319 291 B1 a method is known for controlling a combination consisting of a tractor and a baling press coupled to the tractor, in which method a baling press control unit emits a tractor-stopping signal as the reaction to a demand by the baling press, and a tractor control unit reacts to the tractor-stopping signal by preventing the tractor from moving in the meantime so that the completely formed bale can be ejected at the right moment. The tractor control unit comprises a plurality of control devices which control various tractor systems and tractor components such as brakes, the clutch, the motor and the transmission. The driver has the option of generating a tractor-release signal in order to overrule a stopping signal, whereupon the tractor control unit enable the tractor to move again. The document does not describe which of the tractor's systems or tractor components is caused by the tractor control unit to stop the agricultural combination when commanded to do so by the baling press.

US 2018/0265064 A1 describes a method for controlling the brakes of a tractor having a drive output shaft and, acting upon the drive output shaft, a spring-actuated and hydraulically released (SAHR, Spring applied hydraulic released) parking brake with a pair of friction brake components. When a braking command is received the SAHR brake is actuated, but the braking force is limited as a function of the rotation speed of the drive output shaft.

### SUMMARY

Against this background the purpose of the present invention is to propose a method for controlling the brakes of a vehicle combination consisting of a towing vehicle and an attached accessory device or trailer vehicle coupled to the towing vehicle, with which method better braking behavior is achieved when a braking command has been received. In particular, when hazardous situations are recognized, the vehicle combination should be braked more rapidly. In addition, an electronic brake control system is described, with which such a method can be operated. Finally, a vehicle combination is proposed, which is equipped with such an electronic brake control system.

These objectives are achieved by a method, a brake control system, and a vehicle combination according to the present disclosure.

Thus, the invention first relates to a method for controlling the brakes of a vehicle combination comprising a towing vehicle and, coupled thereto, an attached accessory device or at least one trailer vehicle, wherein the vehicle combination comprises an electronic brake control system and first sensor means for determining the driving speed, wherein at least the towing vehicle comprises a friction brake system that can be actuated by the brake control system, and wherein at least the coupled attached accessory device or trailer vehicle comprises second sensor means for recognizing a need to brae the vehicle combination and to signal the said braking requirement.

To achieve the stated objective, in this method it is provided that a signaled braking demand is communicated directly or indirectly to the brake control system and the vehicle combination is braked automatically by the brake control system in response to a braking demand communicated to the brake control system by actuating at least one friction brake system of the towing vehicle.

Braking of a vehicle combination is understood to mean a deceleration of the vehicle, by negative acceleration, in order to reduce the driving speed or to cut the driving speed completely down to a standstill of the vehicle. A braking demand is understood to mean a corresponding command to brake the vehicle combination.

Thus, the invention relates to a method for operating an off-highway vehicle combination in relation to an automatic actuation of the friction brakes of the towing vehicle when this is called for by an on-board implement or a towed trailer vehicle. By the use of the friction brakes, compared with control methods that use drivetrain components of the vehicle for braking, the response behavior when a braking demand occurs is more spontaneous and more pronounced deceleration is achieved. Owing to the driver's reaction time, automatic braking in particular is, as a rule, initiated more promptly than braking would possibly be if a driver were to actuate the brakes manually. In that way the braking process is made quicker overall. That is above all advantageous in hazardous situations, since accidents can be reliably avoided thereby.

To carry out the method, an electronically controlled friction brake is required, but not the drive motor or a transmission of the vehicle. Basically, the vehicle combination can therefore have a drivetrain of any desired type. The method can be used to good advantage both in vehicle combinations with internal combustion engine drives and with vehicle combinations having electric motor or hybrid drives. The friction brakes can be assisted by the drivetrain, but this is not absolutely necessary. In particular, a continuously variable transmission, as installed more and more often in modern tractors, can be actuated and will be effective for assisting a braking process.

Thus, the vehicle combination can comprise a range-change transmission instead of a continuously variable transmission. In that way the method can be used in a very versatile manner. Accordingly, with the method described vehicles can also be braked automatically in the same way by the friction brakes, whether they have an automatic range-change transmission or an automated manual transmission with or without powershiftable gearshifts. If necessary, a starting clutch in the drivetrain can be electronically decoupled by a control unit, or torque transmission in the drivetrain can be interrupted or regulated in some other way in order to carry out the braking process using the friction brakes, if it needs to be brought to a standstill.

At the end of the braking process the driver can again assume full control over the vehicle and initiate a starting process to move off again or to re-start. The brake control system can be designed such that, if necessary, the driver can at any time intervene in an automatic braking process.

The method can be implemented as an additional brake control function in the TIM tractor implement management system with the ISOBUS Standard ISO 11783 and the SAE J1939 network protocol already explained earlier. That is expedient and advantageous, having regard to the standardization of communications between different product- and/or manufacturer-overarching combinations of towing vehicles and attached accessory devices or trailer vehicles. However, it is not absolutely necessary for communication to take place between the brake control system and the attached accessory device or trailer vehicle. The braking demand can be sent directly from a control unit of the attached accessory device or trailer vehicle to the control unit of the brake control system. Alternatively, indirect communication by way of another control unit is possible, as for example via an existing tractor control unit or a so-termed gateway, i.e., a network connection unit.

Although the description of the invention focuses on agricultural tractor combinations, the invention is not limited to them and can be used with any other off-highway vehicle type equipped with attached accessory devices or trailer vehicles suitable for the purpose.

According to a further development of the method it is provided that when a braking demand has been signaled and sent to the brake control system, a cycle with at least the following process steps is run through at least once:
the current driving speed of the vehicle combination is determined,
the difference between the braking required and a current braking of the vehicle combination is determined,
a torque transmission in the drivetrain of the vehicle combination is interrupted or regulated,
generation and application of a brake pressure acting on the friction brakes of at least one vehicle axle of the towing vehicle, as a function of the difference determined between the required and the actual braking of the vehicle combination, and
braking of the vehicle combination down to a standstill or at least until it is recognized that the situation which led to the braking demand no longer exists.

When the sensor system of the attached accessory device or trailer vehicle recognizes that an operation-relevant or safety-relevant situation exists, braking of the vehicle combination is demanded. The braking command is then sent by a control device of the attached accessory device or trailer vehicle itself or by way of another control unit, for example a tractor control unit, to a brake control unit of the electronic brake control system of the vehicle combination. The extent of the necessary vehicle deceleration, i.e., of the negative acceleration required in order to be able to stop the vehicle combination safely in the shortest possible time, can be estimated by the control unit of the attached accessory device or trailer vehicle. This estimation is important, particularly in the case of an emergency stop. For example, an emergency braking operation can be required if an animal is exposed ahead of the towing vehicle in the area being harvested. An operation-relevant braking can be required, for example, if a task to be performed by the equipment requires a change of driving speed or a deceleration down to a standstill. That can be, for example, the ejection of a bale from a coupled bale-pressing machine.

When the brake control system receives a braking demand, first the current driving speed and a current vehicle deceleration or vehicle acceleration of the vehicle combination are determined. It can be provided that the driving speed and the driving speed change of the vehicle combination are determined with the help of at least two first sensor means arranged on a vehicle axle of the vehicle combination, in the form of wheel rotation speed sensors, a driving speed sensor on a shaft of a vehicle transmission, a vehicle acceleration sensor, a ground radar sensor and/or a satellite navigation system.

Accordingly, in the simplest case the driving speed and the braking or if appropriate the acceleration of the vehicle combination can be determined with the help of at least two wheel-rotation-speed sensors on a vehicle axle. Modern tractors are more often equipped with wheel-rotation-speed sensors. The driving speed and the driving speed change are deduced by means of a suitable software algorithm from the wheel rotation speed data determined and the wheel speed data derived therefrom. The use of more than two wheel-rotation-speed sensors increases the reliability of the deceleration signal and enables additional safety checks to be carried out. Preferably, all the vehicle wheels on which there are wheel-rotation-speed sensors are used for determining the driving speed and the driving speed change. If no wheel-rotation-speed sensors are fitted on individual vehicle wheels, the speed and acceleration data can be obtained from some other available source. For example, the rotation speed of one or more transmission shafts can be measured. From that, information about the speed of the vehicle can be determined.

The brake control system activates the friction brakes by means of a positioning unit which depends on the respective design of the brake system of the vehicle combination, for example an electro-hydraulic or electro-pneumatic valve unit or an electric actuator. In the case of an electro-hydraulic brake unit, the brake control system activates the friction brakes by building up a hydraulic brake pressure by way of an electro-hydraulic proportional valve connected to the friction brakes of at least one axle, for example the rear axle of the tractor. The level of the brake pressure is estimated as a function of the deceleration desired and the deceleration measured, and bearing in mind that the braking process must be able to be carried out safely. A control logic module contained in the brake control system minimizes the difference between the desired and the measured deceleration values by means of a suitable software algorithm, so that the vehicle complies with the desired deceleration value. Preferably, the electro-hydraulic proportional valve is installed parallel to afoot-brake valve, by means of which the driver can override the output of the proportional valve by actuating the brake pedal in order to influence the automatic braking process, if necessary, in particular being able to reinforce it further.

As already mentioned, to carry out the method only one electronically controlled friction brake system is needed, but not any drivetrain-related device. Regardless of that, the friction brakes can be assisted by the drivetrain. In particular, a continuously variable transmission can be used to assist the deceleration. In the case when such transmission assistance is desired, the actuation of the friction brakes can be combined with an actuation of the transmission to adapt the transmission ratio. For example, that can be expedient in a regular work application involving frequent stopping processes, so as to minimize brake wear. In the simplest case, i.e., without assistance of the brakes by a drive motor and/or a transmission, during the braking process the drivetrain is interrupted electronically in the power flow in a controlled manner.

The brake control ends when the required braking is achieved. For example, in a work application with an attached accessory device, a substantial speed reduction may be sufficient. If a hazardous situation is recognized, it is true in most cases that the vehicle combination is braked until the vehicles are at a standstill. However, the vehicle combination need not always be brought to rest if the situation that motivated the braking no longer exists while braking is in progress, for example when an animal has taken flight. The working process, for example the mowing of a meadow, does not then necessarily have to be interrupted. In many cases, a brief speed reduction can already be enough to allow the work to continue safely. Furthermore, in that way the wear of the brakes and other components in the drivetrain, as well as the energy consumption of the drive motor, can be reduced.

In a further embodiment of the invention, it can be provided that after a vehicle combination has been braked until the vehicles are at rest, a holding brake at least of the towing vehicle is actuated automatically. Thanks to this extension of the brake control system, after a successful braking operation down to a standstill the vehicle combination will automatically hold its current position. Particularly on an inclined surface this increases the operational security and the driving comfort. This function also enables the driver, without further brake activity, to leave the towing vehicle in order, if necessary, to remove an inconvenient object from ahead of the towing vehicle.

According to another embodiment of the invention, it can be provided that at the beginning of an automatic process of braking the vehicle combination an acoustic and/or visual warning signal is emitted, and/or after the end of such a braking process an acoustic and/or visual ‘clear’ signal is emitted. For example, the driver can be informed on a display of an electronic terminal device when an automatic braking process is imminent. In that way he is informed that a possibly abrupt braking is not the result of a failed function or a defect of the vehicle that would demand his intervention, but is a braking function initiated in an ordinary way. After the end of the automatic braking process the driver can be informed or informed again. In that way the driver knows when he can resume control and continue driving. This increases the driving comfort and operational security.

It can also be provided that in the case of a vehicle combination having an attached accessory device or a trailer vehicle which comprises a trailer friction brake system of its own that can be actuated by the brake control system, when a braking demand is signaled and communicated to the brake control system the friction brake system of the trailer as well is activated. Thus, in addition to the friction brakes of the towing vehicle, any existing trailer friction brakes of a towed attached accessory device or trailer vehicle are activated by the brake control system, for example by way of a trailer control valve. By virtue of such parallel activation of the brakes of the towing vehicle, and the brakes of a trailer, for example, the braking power and the braking safety are increased.

Furthermore, it can be provided that in the case of a vehicle combination having a towing vehicle which has sensor means of its own for recognizing a need to brake the vehicle combination and for signaling a braking demand, a braking demand by the sensor means of the towing vehicle and/or by the sensor means of the attached accessory device or trailer vehicle is communicated directly or indirectly to the brake control system.

The method according to the invention assumes that for controlling the brakes of the vehicle combination, at least the attached accessory device or trailer vehicle coupled to the towing vehicle comprises second sensor means for recognizing a need to brake the vehicle combination and to signal a braking demand. However, the method can also be carried out to good advantage on the towing vehicle itself, the towing vehicle comprises sensors which can detect an event or condition that is relevant for a braking requirement. In such a case, the attached accessory device or trailer vehicle, as well as the towing vehicle, can trigger a braking process.

It can also be provided that a braking demand by the attached accessory device or trailer vehicle is overridden by a braking demand by the towing vehicle, or conversely, that the braking demand by the towing vehicle is overridden by a braking demand by the attached accessory device or trailer vehicle.

In accordance with a detailed form of a method which conforms with the principle of the invention, the invention can comprise the following process steps:
Step S1: In a vehicle combination, a motor control unit, a transmission control unit, a tractor control unit and a brake control unit of the towing vehicle are ready for operation as well as an attached accessory device control unit, and the brake control unit waits for a command from the attached accessory device control unit.
Step S2: Reception of sensor data from a surroundings detector in the attached accessory device control unit.
Step S3: Recognition of an emergency stop situation by the attached accessory device control unit.
Step S4a: Production of a braking command in the attached accessory device control unit and communication of the braking command to the brake control unit via a control line in accordance with a first command route.
Step S4b: Production of a braking command in the attached accessory device control unit and communication of the braking command via a second command route by means of ISOBUS to the tractor control unit and from there, via CAN data-bus, to the brake control unit.
Step S5: Reception of the braking command in the brake control unit.
Step S6: Ascertainment of the admissibility of the braking command received.
Step S7: Specification of a previously determined maximum admissible value of the target deceleration, as a function of a configuration of the vehicle combination and/or of a driving situation, to be taken into account in the further process sequence if the value of the target deceleration is within a maximum admissible value range.
Step S8: Instructing the transmission control unit to decouple a driving clutch in the drivetrain of the towing vehicle, or instructing the transmission control unit to assist a friction braking operation by controlling and varying a transmission gear ratio.
Step S9: Actuation of a first electronic brake valve and if necessary a second electronic brake valve and if necessary a trailer control valve in order to produce a brake pressure for actuating at least one friction brake system of the towing vehicle and if necessary a friction brake system of the attached accessory device or trailer vehicle by means of the brake control unit, in such manner that the vehicle combination is braked with a deceleration value at most as large as the difference between the value of the target deceleration and the value of the actual speed change, having regard to the maximum admissible value of the target deceleration.
Step S10: Sending of a measured brake pressure value from a first pressure sensor and, if necessary, a measured brake pressure value from a second pressure sensor to the brake control unit.
Step S11: Monitoring the brake pressure.
Step S12: Sending rotation speed signals from at least two wheel-rotation-speed sensors to the brake control unit.
Step S13: Calculation of the current actual speed and the current actual speed change of the vehicle combination from the rotation speed signals received in the brake control unit.
Step S14: Calculation of the difference between the value of the target deceleration and the value of the actual speed change in the brake control unit.
Step S15: Adaptation of the brake pressure so as to minimize the difference between the value of the target deceleration and the value of the actual speed change in the brake control unit, and during this, monitoring the brake pressure.
Step S16: Passing on the braking command to Step S18, if the speed of the vehicle is zero, or otherwise continuing with Step S17.
Step S17: Checking whether a more recent or another braking command is available, and if this is the case, reverting back to Step S6, or otherwise continuing at Step S12.
Step S18: Activating a holding brake.
Step S19: Termination of the process.

In a further form of this detailed process sequence, it can be provided that when actuating a first electronic brake valve, and if necessary, a second brake valve, and if necessary, a trailer control valve to produce a brake pressure, it is taken into account whether the vehicle combination is travelling uphill or downhill, since the brake pressure when driving uphill is lower than when driving downhill. For that purpose, the measurement value from at least one further sensor is used, from which it can be ascertained whether the vehicle combination, or the towing vehicle or tractor, is driving uphill or downhill. Such a sensor can use data from a navigation system, for example. The brake pressure can be lower when driving uphill than downhill because the gravitational force acting on the vehicle assists a deceleration to be brought about.

Since vehicles used in agricultural, forestry or on building-sites can also be loaded or unloaded while driving ahead, another further development of the method for increasing driving safety provides that when actuating a first electronic brake valve, and if necessary a second electronic brake valve, and if necessary a trailer control valve, in order to produce a brake pressure, the current total mass of the vehicle combination is taken into account. Thereby it is recognized that starting from a given driving speed, with equal braked deceleration, an unloaded vehicle needs a lower brake pressure than a vehicle carrying a load.

In addition, it can be provided that when determining a maximum admissible value of the target deceleration it is taken into account whether the vehicle combination is driving transversely to an inclined surface. Here too, the measured value from at least one further sensor is used, with which the inclination of the towing vehicle or tractor transversely to its travel direction can be ascertained. Data from a navigation system can also be used. When a vehicle combination is driving transversely to an inclined surface a comparatively lower maximum admissible value of the target deceleration is specified, since in such operating situations abrupt vehicle movements should be avoided for driving safety reasons.

Furthermore, when determining the brake pressure and when determining a maximum admissible target deceleration, it should be noted whether an attached accessory device or trailer vehicle is coupled to the towing vehicle or tractor, and if so, what kind of attached accessory device or trailer vehicle it is. In that way the effect of the working mode of the attached accessory device or trailer vehicle on the deceleration behavior and the driving safety of the vehicle combination can be taken into account.

To achieve the equipment-related objective, an electronic brake control system of a vehicle combination is provided, the combination comprising a towing vehicle and an attached accessory device and/or at least one trailer vehicle coupled to the towing vehicle. The brake control system comprises sensor and control means for determining the driving speed and for determining a need to brake the vehicle combination and to automatically actuate a friction brake system of the towing vehicle and/or of the attached accessory device or trailer vehicle coupled thereto.

Finally, a vehicle combination is disclosed, which comprises an agricultural tractor with an attached accessory device and/or at least one trailer vehicle, or which comprises some other utility vehicle for off-highway use, with an electronic brake control system that is installed as just described, and that can be operated so as to carry out the method having the features of the invention.

### BRIEF DESCRIPTION OF THE DRAWINGS

Below, the invention will be explained in greater detail with reference to an example embodiment illustrated in the attached drawing, which shows:

FIG. 1: A schematic side view of an agricultural vehicle combination consisting of a tractor and a trailer vehicle with various electronic control units, and

FIG. 2: A circuit diagram of a brake control system for a tractor with a controllable friction brake system, as illustrated in FIG. 1.

### DETAILED DESCRIPTION

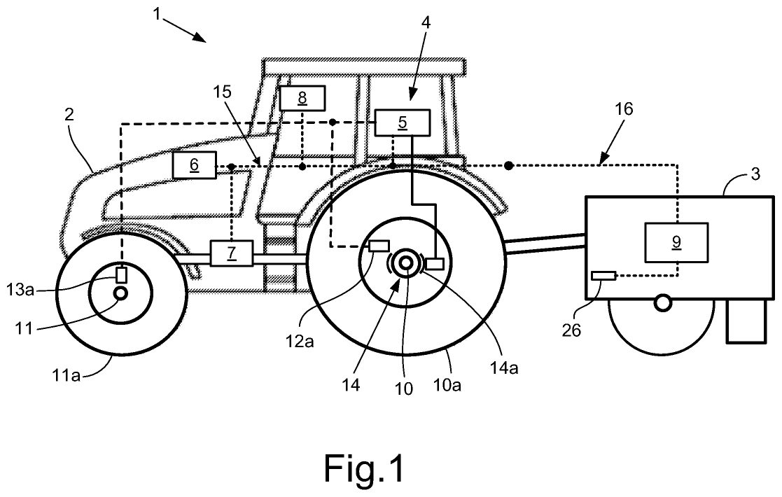

Accordingly, the vehicle combination 1 shown in FIG. 1 consists of a towing vehicle in the form of a tractor 2 and an attached accessory device 3 towed by the tractor 2, which is used for cultivating an agrarian area, for example. If the attached accessory device 3 comprises at least one vehicle wheel, it will be referred to as a trailer vehicle. The vehicle combination comprises various electronic control units, such that a brake control unit 5 is arranged on the tractor 2 and associated with a brake control system 4 of the vehicle combination 1. Moreover, arranged in the tractor there are a motor control unit 6 for controlling a drive motor of the tractor 2, for example a diesel motor, a transmission control unit 7 for controlling a vehicle transmission, for example a continuously variable transmission, and a tractor control device 8. During routine operation, the tractor control device 8 receives various vehicle data, such as the driving speed, the rotation speed of a power take-off shaft powering the attached accessory device 3, and the position of a three-point suspension, and keeps that information available.

In addition, the attached accessory device 3 comprises an electronic attached accessory device control unit 9. If the attached accessory device 3 has at least one vehicle wheel, the said attached accessory device control unit 9 is called a trailer vehicle control unit.

The attached accessory device control unit 9 is provided for the control of task-specific work processes. Furthermore, the attached accessory device control unit 9 is designed to receive sensor signals from sensor means 26 for the recognition of a hazard-related braking need of the vehicle combination 1, and to generate and send braking demands on the grounds of such sensor signals. This will be explained in greater detail below.

The five control units 5, 6, 7, 8, 9 mentioned are linked with one another via a CAN data-bus 15, wherein the attached accessory device control unit 9 and the tractor control unit 8 are connected to one another via an ISOBUS 16. The electrical plug connections and lines between the attached accessory device control unit 9 and the tractor control unit 8 are designed in accordance with the ISO 11783 Standard and the participants communicate in accordance with the SAE J1939 network protocol.

In this example, the tractor comprises first sensor means both on the two rear-axle wheels 10a, 10b of its rear axle and on the two front-axle wheels 11a, 11b of its front axle 11, to detect the driving speed by means of respective wheel rotation speed sensor 12a, 12b, 13a, 13b. The total of four wheel-rotation-speed sensors 12a, 12b, 13a, 13b are connected to the brake control unit 5 by sensor lines (not indexed).

The attached accessory device 3 comprises second sensor means in the form of a surroundings detector 26 for recognizing a need to brake the vehicle combination 1 during routine operation and in unexpected situations. In particular, these sensor means are designed to recognize emergency situations which demand immediate stopping of the vehicle combination 1. Such sensors are already known and are being continually developed further. The surroundings can be recognized with the help of scanners and/or cameras which work in various wavelength ranges and detect the surroundings and/or an operating position. For example, reference can be made to the already mentioned document by Pöttinger Landtechnik GmbH for animal recognition.

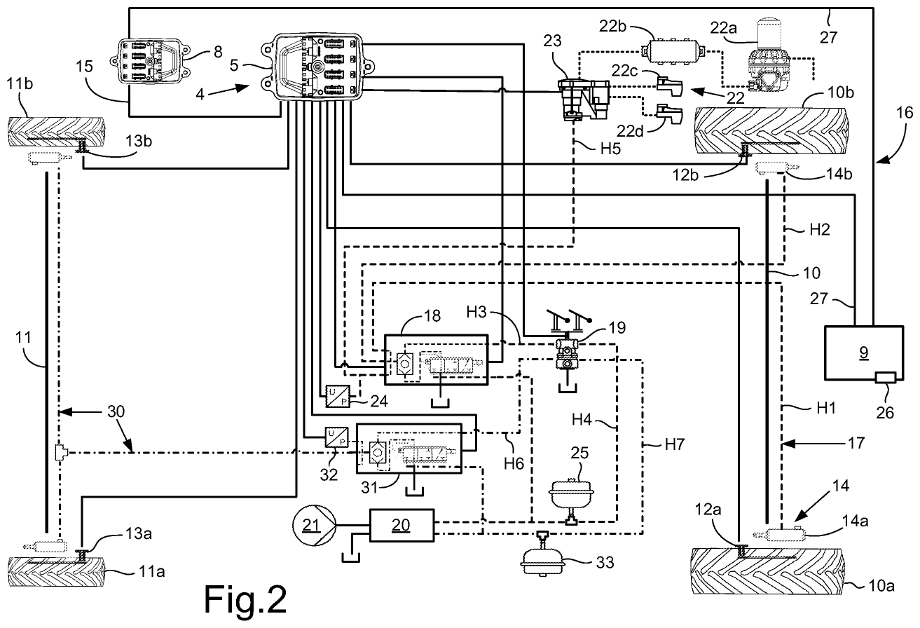

The tractor 2 is equipped with a friction brake system 14, such that in this case a friction brake 14a, 14b with a hydraulic brake cylinder is arranged on each rear-axle wheel 10a, 10b. As shown, as optional equipment the two front-axle wheels 11a, 11b can also be braked by friction brakes. If necessary, the attached accessory device 3 too can comprise a trailer friction brake system 22. This is not shown explicitly in FIG. 1 but is provided in FIG. 2 as optional equipment. The important thing here is only that the tractor 2 has a friction brake system on one axle, as a rule the rear axle 10. The friction brake system 14 shown in FIGS. 1 and 2 is in this example in the form of an electro-hydraulic brake unit and can be actuated by the brake control unit 5. This will be described in greater detail below.

FIG. 1 then, shows a circuit diagram of the brake control system 4 for controlling the brakes of the friction brake system 14 of the towing vehicle 2 in the form of a tractor, with a first hydraulic brake circuit 17 as in FIG. 1 and with an optionally provided second hydraulic brake circuit 30, which is only provided for the case when, as indicated, the tractor 2 is also equipped with friction brakes on the front-axle wheels 11a, 11b. Accordingly, a first electronic brake valve 18 is arranged in the first brake circuit 17, which is hydraulically connected via a first hydraulic line H1 and a second hydraulic line H2, respectively, to associated brake cylinders of the first friction brake 14a and the second friction brake 14b of the rear-axle wheels 10a and 10b. In addition, the first brake valve 18 is connected by a third hydraulic line H3 to a foot-brake valve 19, which for its part is hydraulically connected via a fourth hydraulic line H4 and a storage charging valve 20 with a pressure-limiter to a hydraulic pump 21. In the fourth hydraulic line H4 there is also integrated a first hydraulic pressure accumulator 25. For measuring and monitoring the hydraulic pressure, the first brake circuit 17 has a first pressure sensor 24 which is electrically connected to the brake control unit 5 of the brake control system 4.

As already mentioned, the second hydraulic brake circuit 30 is only provided for the case when the tractor 2 is also equipped with friction brakes on the front-axle wheels 11a, 11b (not shown in FIG. 1). The optional second hydraulic brake circuit 30 shown in FIG. 2 has a second electronic brake valve 31 connected via a sixth hydraulic line H6 to the foot-brake valve 19 and from there, via a seventh hydraulic line H7, via the storage charging valve 20 to the hydraulic pump 21. In the seventh hydraulic line H7 there is also integrated a second hydraulic pressure accumulator 33. The second hydraulic brake circuit 30 also includes a second pressure sensor 32, which is electrically connected via a further sensor line (not indexed) to the brake control unit 5. Thus, the structure of the second brake circuit 30 corresponds essentially to that of the first brake circuit 17. The difference from the first brake circuit 17 is that a common hydraulic line is provided for the optional front-axle brakes.

In the case when the attached accessory device 3 comprises a trailer friction brake system 22 of its own, according to the example circuit diagram shown in FIG. 2, a further, fifth hydraulic line H5 is provided in the first brake circuit 17, which connects the first brake valve 18 hydraulically on the input side to a trailer control valve 23. In a known configuration, the trailer control valve 23 comprises a number of directional valves that can be actuated electrically by the brake control unit 5. Thus, in this case the trailer control valve 23 is integrated in the hydraulic brake circuit of the tractor 2 and can be activated by the brake control unit 5 in order to actuate the (only partially shown) trailer friction brake system 22. In this example the trailer friction brake system 22 is in the form of a pneumatic brake unit. The interface between the trailer control valve 23 and the trailer friction brake system 22 is designed in accordance with the EU guideline EU2015-68 and needs no further explanation here. By means of the trailer control valve 23 a pneumatic supply pressure produced by an air compressor 22a can be delivered via a compressed-air tank 22b to a supply pressure coupling head 22c. A pneumatic supply pressure line (not shown) of the trailer friction brake system 22 can be coupled to the supply pressure coupling head 22c. In addition, the trailer control valve 23 has on its outlet side a control pressure outlet which is connected to a control pressure coupling head 22d. A pneumatic control pressure can be delivered to this control pressure coupling head 22d for the friction brakes of the trailer friction brake system 22. Accordingly, a pneumatic control pressure line (not shown) of the trailer friction brake system 22 can be coupled to the control pressure coupling head 22d, so that the brake cylinders of the friction brakes of the attached accessory device 3 can be acted upon by the control pressure when braking is required.

The first brake circuit 17 and, if it is present, the second brake circuit 30 is/are connected electrically to the brake control unit 5 and can be actuated by it. Furthermore, the brake control unit 5 is electrically connected to the tractor control unit 8 by the CAN data-bus 15 already mentioned. The tractor control unit 8 is also connected via the ISOBUS 16 to the attached accessory device control unit 9 of the attached accessory device 3. As an alternative data connection, FIG. 2 shows a direct electrical control line 27 between the attached accessory device control unit 9 and the brake control unit 5. Thus, the attached accessory device control unit 9 can send a braking command via the tractor control unit 8 to the brake control unit 5 or, in the said alternative embodiment, directly to the brake control unit 5. Furthermore, the brake control unit 5 is electrically connected individually via sensor lines (not indexed) to the first sensor means in the form of four wheel-rotation-speed sensors 12a, 12b, 13a, 13b.

A method having the characteristic features of the invention can be carried out with the vehicle combination 1 according to FIG. 1 and is described below. For this example, the brake control system 4 works with an algorithm which is stored completely or partially in the brake control unit 5, in the tractor control unit, and in the attached accessory device control unit 9, and operated therein. According to the said algorithm the following process steps are provided:
Step S1: A vehicle combination 1 contains, ready for operation, a motor control unit 6, a transmission control unit 7, a tractor control unit 8, and a brake control unit 5 of the towing vehicle 2, as well as an attached accessory device control unit 9, and the brake control unit 5 waits for a command from the attached accessory device control unit 9.
Step S2: Reception of sensor data from a surroundings detector 26 in the attached accessory device control unit 9.
Step S3: Recognition of an emergency stop situation by the attached accessory device control unit 9.
Step S4a: Production of a braking command in the attached accessory device control unit 9 and communication of the said braking command to the brake control unit 5 via a control line 27 in accordance with a first command route, or
Step S4b: Production of a braking command in the attached accessory device control unit 9 aid communication of the said braking command in accordance with a second command route by way of ISOBUS to the tractor control unit 8 and from there, by means of the CAN data-bus 15, to the brake control unit 5.
Step S5: Reception of the braking command in the brake control unit 5.
Step S6: Ascertainment of the admissibility of the braking command received.
Step S7: Specification of a previously determined maximum admissible value of the target deceleration, as a function of a configuration of the vehicle combination 1 and/or of a driving situation, to be taken into account in the further process sequence if the value of the target deceleration is within a maximum admissible value range.
Step S8: Instructing the transmission control unit 7 to decouple a driving clutch in the drivetrain of the towing vehicle 2, or instructing the transmission control unit 7 to assist a friction braking operation by controlling and varying a transmission gear ratio.
Step S9: Actuation of a first electronic brake valve 18 and, if necessary, a second electronic brake valve 31 and, if necessary, a trailer control valve 2 in order to produce a brake pressure for actuating at least one friction brake system 14 of the towing vehicle 2 and if necessary a friction brake system 22 of the attached accessory device 3 or trailer vehicle by means of the brake control unit 5, in such manner that the vehicle combination 1 is braked with a deceleration value at most as large as the difference between the value of the target deceleration and the value of the actual speed change, having regard to the maximum admissible value of the target deceleration.
Step S10: Sending of a measured brake pressure value from a first pressure sensor 24 and, if necessary, from a second pressure sensor 31 to the brake control unit 5.
Step S11: Monitoring of the brake pressure.
Step S12: Sending of rotation speed signals from at least two wheel-rotation-speed sensors 12a, 12b, 13a, 13b to the brake control unit 5.
Step S13: Calculation of the current actual speed and the current actual change of speed of the vehicle combination 1 from the rotation-speed signals received in the brake control unit 5.
Step S14: Calculation in the brake control unit 5, of the difference between the value of the target deceleration and the value of the actual deceleration.
Step S15: Adaptation in the brake control unit 5, of the brake pressure so as to minimize the difference between the value of the target deceleration and the value of the actual speed change, and during this, monitoring of the brake pressure.
Step S16: Passing on the braking command to Step S18, if the speed of the vehicle is zero, or otherwise continuing with Step S17.
Step S17: Checking whether a more recent or another braking command is available, and if this is the case, reverting back to Step S6, or otherwise continuing at Step S12.
Step S18: Activating a holding brake.
Step S19: Termination of the process.

By virtue of these process steps, in a recognized operating situation that demands a braking of the vehicle combination 1, an automatic braking process is carried out by means of the actuated friction brakes 14, 14a, 14b, 22. By actuating the brake pedal, the driver can override the braking process by means of the foot-brake valve 19. In particular, in an emergency braking situation the driver can reinforce the automatic braking process by actuating the brake pedal. During regular operation with the attached accessory device 3, a further development of the control is also possible, in which the driver can interrupt or cancel an automatic braking process. In the present example, however, that is not relevant and therefore not provided.

In the Step S8 mentioned, the current actual speed and the current actual speed change of the vehicle combination 1 is calculated from the rotation speed signals received in the brake control unit 5. The terms “deceleration” or “braking” mean a negative speed change. The term “acceleration” means a positive speed change. Correspondingly, in this context decelerations of the vehicle combination 1 are understood to be negative values of the speed change and accelerations of the vehicle combination 1 are understood to be positive values of the speed change.

The value of the target deceleration received by way of the braking command in Step S7 mentioned above can later on be adapted in order not to exceed a maximum admissible value of the target deceleration for stopping safely. Upon recognition of an emergency situation, the vehicle combination 1 should not be stopped with an arbitrarily high vehicle deceleration. Namely, the target deceleration should not be so high that the driver could be injured during an abrupt braking process, or that the vehicle combination 1 is forced into a driving situation which compromises safety. Thus, in the simplest case a comparatively low value of the target deceleration can be determined for use in the continuing process sequence and stored in the brake control unit. This possibly results in a comparatively long stopping distance. However, the advantages of greater driving safety and protecting the vehicles driver against injury predominate. To determine the value of a maximum admissible target deceleration, stored data about the configuration of the vehicle, such as the type of towing vehicle and the type of attached accessory device or trailer vehicle coupled thereto, the overall weight of the vehicle combination 1 and/or the number of vehicle axles that can be braked can be referred to.

Furthermore, the current driving situation can be taken into account. Accordingly, the brake pressure when driving on a downhill stretch will be different from the brake pressure when driving uphill. This is taken into account for actuating the first electronic braking valve 18 and, if necessary, the second braking valve 31 or the trailer control valve 23 to produce the brake pressure.

Moreover, so as to avoid any tendency to tip over, the value of the maximum admissible target deceleration can take into account whether the vehicle combination is moving over an at least largely horizontal stretch or transversely to a slope or gradient.

It is also regarded as advantageous for the target deceleration value to be calculated afresh for each process cycle, since a loading or unloading process taking place during the journey changes the overall mass of the vehicle combination and therefore also the deceleration required in the event of an emergency braking operation.

For example, in the Step S7 mentioned earlier, in an emergency stop situation a required target deceleration of −6 m/s² is estimated or calculated in some other way in order to bring the vehicle combination 1 to a standstill in the shortest time and with the smallest brake travel path. However, for reasons of driving safety, a maximum target deceleration value of −5 m/s² is determined. Due to the maximum target deceleration of −5 m/s², in Step S9 the friction brake system 14 is then actuated in such manner that the vehicle combination 1 is braked with a deceleration value of −5 m/s², i.e., the maximum admissible deceleration value. If, in a different operating situation, the estimated target deceleration value was lower than the maximum admissible target deceleration, then in Step S9 a more gentle braking, i.e., one with a deceleration value lower than the maximum admissible value, could be carried out.

### INDEXES

1 Vehicle combination
2 Towing vehicle, tractor
3 Attached accessory device, trailer vehicle
4 Brake control system
5 Brake control unit
6 Motor control unit
7 Transmission control unit
8 Tractor control unit
9 Attached accessory device control unit
10 Rear axle
10a First rear-axle wheel
10b Second rear-axle wheel
11 Front axle
11a First front-axle wheel
11b Second front-axle wheel
12a First wheel rotation speed sensor, first sensor means
12b Second wheel rotation speed sensor, first sensor means
13a Third wheel rotation speed sensor, first sensor means
13b Fourth wheel rotation speed sensor, first sensor means
14 Friction brake system of the towing vehicle
14a First friction brake
14b Second friction brake
15 CAN data-bus
16 ISOBUS
17 First hydraulic brake circuit
18 First electronic brake valve
19 Foot-brake valve
20 Storage charging valve
21 Hydraulic pump
22 Friction brake system of the attached accessory device or the trailer vehicle
22a Air compressor
22b Compressed-air tank
22c Supply pressure coupling head
22d Control pressure coupling head
23 Trailer control valve
24 First pressure sensor
25 First hydraulic pressure accumulator
26 Surroundings detector, second sensor means
27 Control line from the attached accessory device control unit to the brake control unit
30 Second hydraulic brake circuit
31 Second electronic brake valve
32 Second pressure sensor
33 Second hydraulic pressure accumulator
H1 First hydraulic line
H2 Second hydraulic line
H3 Third hydraulic line
H4 Fourth hydraulic line
H5 Fifth hydraulic line
H6 Sixth hydraulic line
H7 Seventh hydraulic line

1-18. (canceled)

19. A method for controlling the brakes of a vehicle combination (1), the method comprising:
providing a vehicle combination (1) having a towing vehicle (2), an attached accessory device (3) or at least one trailer vehicle coupled to the towing vehicle (2), an electronic brake control system (4), and first sensor means (12a, 12b, 13a, 13b) for determining the driving speed, wherein at least the towing vehicle (2) comprises a friction brake system (14) configured to be controlled by the electronic brake control system (4), and wherein at least the coupled attached accessory device (3) or the at least one trailer vehicle comprises second sensor means (26) for recognizing a need to brake the vehicle combination (1) and to signal a braking demand;
communicating a signaled braking demand directly or indirectly to the electronic brake control system (4); and
automatically braking the vehicle combination (1), by the electronic brake control system (4) and in response to the signaled braking demand, by actuating at least the friction brake system (14) of the towing vehicle (2).

20. The method according to claim 19, comprising performing a cycle of processes at least once in response to communicating the braking demand to the brake control system (4), the cycle of processes comprising:
determining a current driving speed of the vehicle combination (1),
determining a difference between a required braking and a current braking of the vehicle combination (1);
regulating a torque transmission in the drivetrain of the vehicle combination (1),
producing and applying a brake pressure acting on friction brakes (14, 14a, 14b) of at least one vehicle axle (10) of the towing vehicle (2) as a function of the difference determined between the required braking and the current braking of the vehicle combination (1); and
continuing automatically braking the vehicle combination (1) until recognizing that the situation which gave rise to the braking demand no longer exists.

21. The method according to claim 20, wherein regulating the torque transmission includes interrupting the torque transmission.

22. The method according to claim 20, wherein continuing automatically braking the vehicle combination includes braking the vehicle combination to a standstill.

23. The method according to claim 22, comprising:
confirming that the vehicle combination is at the standstill; and
automatically actuating a holding brake.

24. The method according to claim 20, comprising determining a change in the current driving speed of the vehicle combination, wherein determining the current driving speed and determining the change in the current driving speed of the vehicle combination is performed by means of first sensor means (12a, 12b, 13a, 13b) including one or more of (i) at least two wheel-rotation-speed sensors arranged on a vehicle axle (10, 11) of the vehicle combination (1), (ii) at least one rotation speed sensor on a transmission shaft of a vehicle transmission, (iii) at least one driving acceleration sensor, (iv) at least one ground radar sensor, and/or (v) a satellite navigation system.

25. The method according to claim 19, comprising:
producing an acoustic and/or visual warning signal for a vehicle driver at a beginning automatically braking the vehicle combination (1).

26. The method according to claim 25, comprising:
ending automatically braking the vehicle combination; and
emitting an acoustic and/or visual “clear” signal after ending automatically braking the vehicle combination.

27. The method according to claim 19, wherein the attached accessory device (3) or the at least one trailer vehicle has a trailer friction brake system (22) configured to be actuated by the brake control system (4), the method further comprising:
actuating the trailer friction brake system (22) in response to communicating the signaled braking demand to the brake control system (4).

28. The method according to claim 19, wherein the towing vehicle (2) has sensor means for recognizing the braking demand and for signaling the braking demand, wherein the attached accessory device (3) or the at least one trailer vehicle has sensor means, and wherein communicating the braking demand is performed by the sensor means of the towing vehicle directly or indirectly to the brake control system (4) and/or by the sensor means (26) of the attached accessory device (3) or the at least one trailer vehicle.

29. Method according to claim 19, comprising:
overriding a braking demand of the attached accessory device (3) or the at least one trailer vehicle by a braking demand of the towing vehicle (2), or overriding a braking demand of the towing vehicle (2) by a braking demand of the attached accessory device (3) or the at least one trailer vehicle.

30. The method according to claim 19, comprising:
wherein providing the vehicle combination (1) includes providing a motor control unit (6), a transmission control unit (7), a tractor control unit (8), and a brake control unit (5) of the towing vehicle (2), and providing a control unit (9) of the attached accessory device (3) or the at least one trailer vehicle, are ready for operation;
awaiting, by the brake control unit (5), a command from the attached accessory device control unit (9);
receiving sensor data from a surroundings detector (26) in the attached accessory device control unit (9);
recognizing an emergency stop situation by the attached accessory device control unit (9);
producing a braking command in the attached accessory device control unit (9) and (i) communicating the braking command to the brake control unit (5) by way of a control line (27) of a first command route, or (ii) communicating the braking command to the tractor control unit (8) by way of ISOBUS (16) and a CAN data-bus to the brake control unit (5);
receiving the braking command by the brake control unit (5);
ascertaining the admissibility of the braking command received;
specifying a previously determined maximum admissible value of the target deceleration, as a function of a configuration of the vehicle combination (1) and/or of a driving situation, to be taken into account in the further process sequence when the value of the target deceleration is within a maximum admissible value range;
instructing the transmission control unit (7) to (i) decouple a driving clutch in the drivetrain of the towing vehicle (2), or (ii) assist a friction braking operation by controlling and varying a transmission gear ratio;
actuating, by the brake control unit (5) a first electronic brake valve (18) and, if necessary, a second electronic brake valve (31) and, if necessary, a trailer control valve (23) in order to produce a brake pressure for actuating at least one friction brake system (14) of the towing vehicle (2) and, if necessary, a friction brake system (22) of the attached accessory device (3) or trailer vehicle in such manner that the vehicle combination (1) is braked with a deceleration value at most as large as a difference between a target deceleration and an actual speed change, having regard to the maximum admissible value of the target deceleration;
sending a measured brake pressure value from a first pressure sensor (24) and, if necessary, a measured brake pressure value from a second pressure sensor (31) to the brake control unit (5);
monitoring the brake pressure;
sending rotation speed signals from at least two wheel-rotation-speed sensors (12a, 12b, 13a, 13b) to the brake control unit (5);
calculating a current actual speed and a current actual speed change of the vehicle combination (1) from the rotation speed signals received in the brake control unit (5);
calculating, in the brake control unit, the difference between the target deceleration and the actual speed change;
adapting a brake pressure so as to minimize the difference between the target deceleration and the actual speed change in the brake control unit (5), and during this, monitoring the brake pressure;
checking, when the speed of the vehicle is not zero, whether a more recent or another braking command is available; and
activating a parking brake when the speed of the vehicle is zero.

31. The method of claim 30, comprising:
reverting back to ascertaining the admissibility of the braking command received, when another braking command is available or otherwise continuing with sending rotation speed signals from at least two wheel-rotation-speed sensors to the brake control unit.

32. The method according to claim 30, wherein actuating the first electronic brake valve (18) and, if necessary, the second electronic brake valve (31) and, if necessary the trailer control valve (23) to produce the brake pressure includes taking into account whether the vehicle combination (1) is driving on an uphill or a downhill stretch.

33. The method according to claim 30, wherein actuating the first electronic brake valve (18) and, if necessary, the second electronic brake valve (31) and, if necessary, the trailer control valve (23) to produce the brake pressure includes taking into account a current overall mass of the vehicle combination (1).

34. The method according to claim 30, wherein the vehicle combination (1) has the attached accessory device (3) coupled to the towing vehicle (2), and wherein actuating the first electronic brake valve (18) and, if necessary, the second electronic brake valve (31) and, if necessary, the trailer control valve (23) to produce the brake pressure includes taking into account a type of the attached accessory device (3).

35. The method according to claim 30, wherein the vehicle combination (1) has the at least one trailer vehicle coupled to the towing vehicle (2), and wherein actuating the first electronic brake valve (18) and, if necessary, the second electronic brake valve (31) and, if necessary, the trailer control valve (23) to produce the brake pressure includes taking into account a kind of the at least one trailer vehicle.

36. The method according to claim 30, wherein determining the maximum admissible value of the target deceleration includes taking into account whether the vehicle combination (1) is driving transversely to a gradient.

37. The method according to claim 30, wherein the vehicle combination (1) has the attached accessory device (3) coupled to the towing vehicle (2), and wherein determining the maximum admissible value of the target deceleration includes taking into account a kind of the attached accessory device (3).

38. The method according to claim 30, wherein the vehicle combination (1) has the at least one trailer vehicle coupled to the towing vehicle (2), and wherein determining a maximum admissible value of the target deceleration includes taking into account a kind of the at least one trailer vehicle.

39. An electronic brake control system (4) of a vehicle combination (1) which comprises a towing vehicle (2) and an attached accessory device (3) and/or at least one trailer vehicle coupled to the towing vehicle (2), wherein the brake control system (4) comprises sensor means (12a, 12b, 13a, 13b, 26) and control means for determining the driving speed and for determining a need to brake the vehicle combination (1) and for the automatic actuation of a friction brake system (14) of the towing vehicle (2) and/or of the coupled attached accessory device (3) or trailer vehicle.

40. A vehicle combination (1) comprising an agricultural tractor (2) with an attached accessory device (3) and/or at least one trailer vehicle, the agricultural tractor having an electronic brake system (4) constructed in accordance with the equipment-related claims and configured to be operated so as to carry out a method in accordance with claim 19.
